(19) United States
(12) Patent Application Publication
(10) Pub. No.: US 2017/0068973 A1
(43) Pub. Date: Mar. 9, 2017

(54) SYSTEM AND METHOD FOR INVENTORY MANAGEMENT

(71) Applicant: Dimitri Sinkel, Lunenburg, MA (US)

(72) Inventor: Dimitri Sinkel, Lunenburg, MA (US)

(21) Appl. No.: 15/354,448

(22) Filed: Nov. 17, 2016

Related U.S. Application Data
(63) Continuation-in-part of application No. 14/094,923, filed on Dec. 3, 2013, now abandoned.
(60) Provisional application No. 61/732,552, filed on Dec. 3, 2012.

(51) Int. Cl. G06Q 30/02; G06Q 10/08

(52) U.S. Cl. CPC G06Q 30/0202; G06Q 10/087; G06Q 30/0201

(57) ABSTRACT

An inventory management system and method computes a safety stock level for each day of the week based on specific historical data for that day of the week, independent of other days in the sales cycle. The inventory management system therefore accommodates cyclic trends over different days of the week (or other sales periods) to identify a forecast error specific to the day of the week, rather than an average over many days, and allow for a safety stock level as recorded by surges on a particular day due to random factors. The generated safety stock levels generate for each SKU (Item at a location) inventory replenishment criteria streamlined to order only those quantities needed to maintain the safety stock level, and further assure that a near complete in-stock percentage (such as 95% or 97%) is maintained. The system generates ordering quantities that are specific to the day of the week calculated over a week of sales.

### RELATED APPLICATIONS

This patent application is a continuation-in-part (CIP) under 35 U.S.C. §120 of U.S. patent application Ser. No. 14/094,923, filed Dec. 3, 2013, entitled “SYSTEM AND METHOD FOR INVENTORY MANAGEMENT,” which claims the benefit under 35 U.S.C. §119(e) of U.S. Provisional Patent App. No. 61/732,552, filed Dec. 3, 2012, entitled “SYSTEM AND METHOD FOR INVENTORY MANAGEMENT,” incorporated herein by reference in entirety.

### BACKGROUND

Historically, inventory control systems relied upon amassing sufficient quantities of goods at or near the location where they were to be consumed, sold, or manufactured into other goods. Particularly in an environment with many different items, it was more problematic to track diminishing quantities of individual items than to maintain a relatively large stock of all or most items. Large warehouse space was often needed near a distribution or consumption point, such as a retail store. As with most industries, computer based innovations facilitated efficiency, and the use of information technology such as databases and stock management such as bar (UPC) codes became commonplace. Bar codes allowed rapid inventory updating, so that the granularity of shortfalls and reordering needs became specific to individual items. It was no longer necessary to maintain large warehouses or stock areas because a shortfall in a particular item was identifiable, and inventory shipments could be tailored to specific items.

### SUMMARY

An inventory management system and method computes a safety stock level for each day of the week based on specific historical data for that day of the week, and its context in a weekly sales cycle. The inventory management system therefore accommodates upward and downward trends over different days of the week (or other sales periods) to identify a required safety stock quantity specific to the day of the week, rather than an average over many days, and plans for a safety stock level as recorded by surges on a particular day due to random factors. The generated safety stock levels indicate a per-item inventory replenishment criteria streamlined to order only those items needed to maintain the safety stock level, and further assure that a targeted in-stock percentage (such as 95% or 97%) is maintained.

Configurations herein are based, in part, on the observation that modern information processing systems and product labeling, including bar codes and RFID (Radio Frequency ID) tags, allow inventory levels to be updated continuously with sales, as an item is deleted from inventory concurrent with a scan of the product ID (i.e. bar code) at a point of sale (POS) register. Retail locations do not need to engage in global or all-encompassing inventory replenishment or manual inventory practices, since the POS and inventory tracking systems identify product levels (inventory) in a continuous, real-time manner.

Unfortunately, conventional approaches to inventory management suffer from the shortcoming that safety stock inventory levels are not optimally calculated for each day of the week. Accordingly, configurations herein substantially overcome the above described shortcomings by generating safety stock quantities that are specific to a day of the week (or other sales period) calculated over a week of sales. A safety stock also addresses variations in observed trends, as which might occur from external events. In contrast to conventional approaches, computation of safety stock and accommodating the safety stock quantities for stock replenishment orders, mitigates stocking shortfalls that can arise from conventional order cycles for retail stock. The safety stock takes into account variations over days of the week shown by previous sales history. Such variations are unique to retail stock, due to variations in consumer activity, and are not found in other stocking contexts such as manufacturing or services.

A Daily Retail Inventory Service Target (DRIST) system and model is based on statistical inference of systematic bias and random error of historic POS sales data, utilizing a Day of the Week (DOW) analysis over a Variable Forecast Interval (VFI), and therefore optimizing inventories in a retail environment. The DRIST model sets a target customer service level (Service Target), for example, 95%, and automatically drives down inventories to their lowest possible level while assuring that the Service Target is realized every day, for every product, at every location. The proposed approach smoothes out the day to day fluctuations often seen in In-Stocks, orders, shipments, and inventories. Maintaining the in-stock percentage at the Service Target ensures customer loyalty and reduces lost sales while simultaneously reducing inventory requirements and cutting inventory carrying costs. The resulting mitigation of fluctuations in inventories, orders, and shipments further improves overall efficiency of operations.

The service target specifies the percentage of locations that are expected to be in stock with a particular item at any given time. It should also be emphasized that in the context of this discussion an item at a location is designated as a SKU (stock keeping unit), thus the same product offering at two different locations designates two separate SKUs. Put another way, a SKU represents attributes of a sale offering and may include manufacturer, product description/type, material, size, color, and packaging, in addition to location, for example.

The DRIST Model utilizes a Variable Order Interval (VOI) which accommodates this fixed order cycle and computes a Safety Stock Quantity (SSDOW) including all the safety stock requirements until the next order can be placed. Since the disclosed approach is specific to each day of the week, and to each item in inventory, surpluses and shortages that occur with daily averaging are avoided. Such a sales period oriented approach avoids depletions that can occur with high volume items during a spike in demand, and avoids excess stock of slower moving inventory that consumes unnecessary retail and transport resources.

With the level of granularity and the relatively low levels of inventory based on daily deliveries, it is beneficial to calculate precise demand variability, down to the daily demand detail level. In fact, with a daily delivery model, it is quite inaccurate to reference average demand and average variability over any period longer than one day. The DRIST Model computes the optimized Day-of-the-Week Safety Stock Quantity (SSDOW) based on a daily, DOW analysis for bias and error.

Conventional approaches to inventory stocking treat each day the same, which is accurate in industrial or manufacturing settings where inventory consumption is under the direct management control. Retail, in contrast, is driven by indefinite consumer behavior, as inventory movement is generally discretionary and subject to serendipitous consumer flow, also influenced by other factors such as weather, seasonal need, holidays, etc. In short, the retail consumer is unpredictable.

The claimed approach computes an estimated safety stock for accommodating the fleeting psyche of the consumer by using the previous 4-7 weeks of a particular day of the week as an indicator of inventory flow (i.e. previous 4 Saturdays, previous 7 Mondays), since there is no better predictor of when a carefree consumer is likely to peruse the aisles of a retail establishment. Contrast this with a manufacturing or industrial environment where a definite number of workers are held to a fixed number of hours for generating a quota of items.

The claimed approach does not represent an absolute guarantee; all it represents is an estimate of inventory flow based on observations of previous consumer behavior. It is not a definite formula because there is nothing to prevent 50 consumers from purchasing item X on a particular Saturday, even though the previous 4 Saturdays only 10 of item X were sold. In the realm of retail, vast resources are expended in attempting to predict consumer activity, and selecting and transporting merchandise to POS locations accordingly. Factors such as time of year, popular trends, media exposure, price points and others are but a few of the variables considered in the countless hours spent by retailers in attempts to place able purchasers in proximity to appealing merchandise.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of an inventory management environment suitable for use with configurations herein;

FIG. 2 is a flowchart of inventory management in the system of FIG. 1;

FIG. 3 depicts safety stock in the managed inventory of FIG. 1;

FIG. 4 shows differences in inventory levels between conventional approaches and the configurations disclosed herein; and

FIG. 5 shows inventory levels (in-stock %) based on the system of FIG. 2.

### DETAILED DESCRIPTION

A particular configuration, discussed as an example below, depicts the Daily Retail Inventory Service Target (DRIST) system and method for accommodating different sales periods presented by different days of the week and the sales and sales variability as indicated by previous history, typically 4-7 weeks of sales data.

Inventory management methods originally evolved to serve large manufacturers, and the conventional, well known Reorder Point (ROP) Model works well in that business environment. In retail, planners still generally manage safety stock levels empirically, usually as a number of days of forward coverage, based on experience. But whenever statistical methods are used, they are invariably variations of the ROP Model. Unfortunately, the ROP Model does not work well for retail, which is especially troubling because safety stock levels are so much more critical for retail goods.

In manufacturing, safety stock is a small part of the inventory compared with cycle stock which supports the actual sales. In retail, the opposite is true: safety stock comprises 60% to 90% of the total inventory. So, in retail, the effective management of safety stock actually has more impact than improving the forecast accuracy of sales, which only affects cycle stock. Until now, there has been little attention focused on improving inventory control in the retail sector—at distribution centers and stores.

Until recently, software and hardware capacities had not evolved to the point where they could support the volumes entailed in daily, store level retail planning. Thus, it was natural for early practitioners to try to apply the traditional Reorder Point Model (ROP) as a starting point to managing retail inventories. Such conventional approaches encountered at least three shortcomings:

1. Reorder Point is not Useful in Retail, which has a Fixed Order Cycle

In manufacturing, planning cycles are measured in weeks and months, reflecting process durations and raw material batches. The ROP model calculates when to place the next order, based on average forecasted demand. In the retail environment, ordering is prescheduled within the planning cycle, usually every day or on certain days of each week, based strictly on the calendar.

2. Demand Variability is not Uniform—Day-of-the-Week Matters

The ROP Model assumes variability is stable throughout the lead time and thus calculates safety stock as a function of average variability of demand and supply over the lead time. However, retail operations are very sensitive to variations by Day-of-the-Week (DOW), both in terms of the forecasted demand (sales velocity) and demand variability, the forecast error. Furthermore, the two are not necessarily related to each other. The highest daily forecast is often Saturday, but the highest forecast error often occurs on Sunday or Monday.

3. Forecasting Interval should Align with Lead Time and Order Cycle

The ROP model calculates demand variability based on forecasting models that use a weekly or monthly forecasting interval, with the implicit assumption that those intervals line up with order lead times. In the retail environment, where order lead times are measured in days rather than weeks, forecast error varies by DOW, and is not directly related to weekly forecast error. The DRIST Model computes forecast error over a Variable Forecast Interval (VFI), which is equal to the actual order lead time by DOW, plus the Variable Order Interval (VOI).

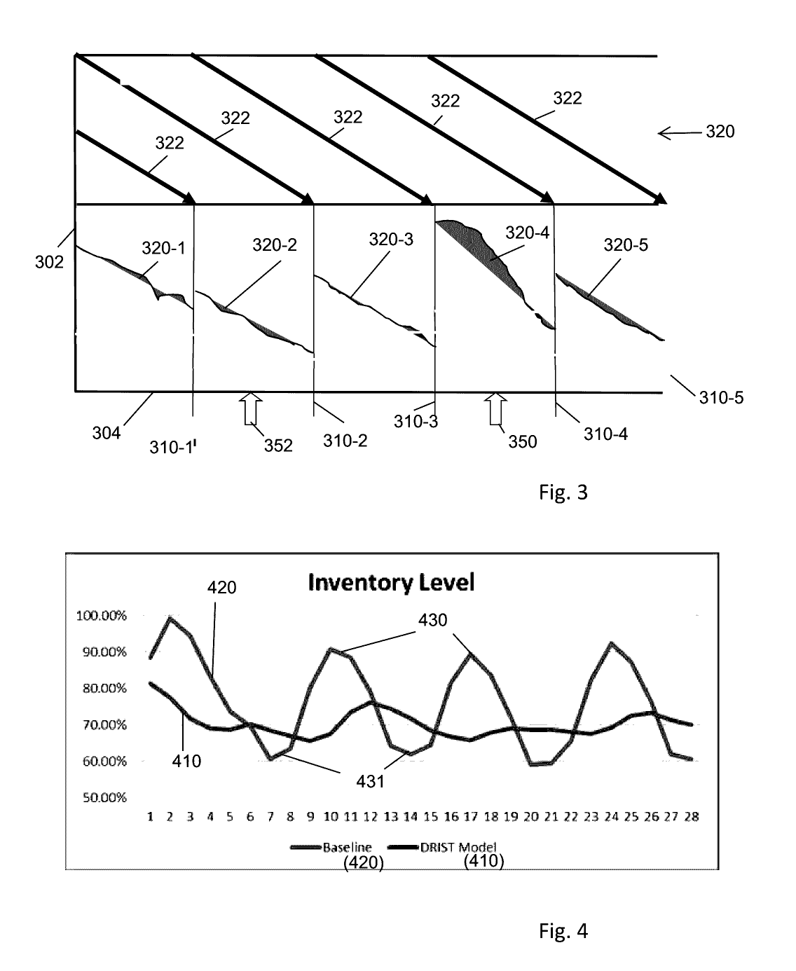

In real world retail applications, detailed below in FIGS. 3 and 4, the DRIST model has been proven to maintain reliable, consistent In-Stock levels, at or above the planner's Service Target, while reducing Inventory requirements to their lowest possible level. At the same time, the DRIST model smooths out the day-to-day fluctuations we often see in In-Stocks, orders, shipments, and inventories.

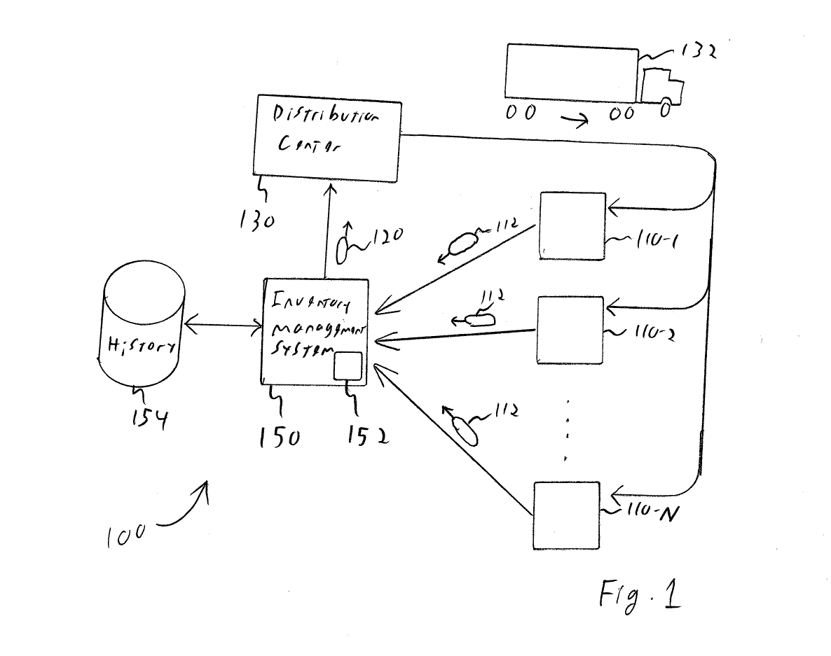

FIG. 1 is a context diagram of an inventory management environment suitable for use with configurations herein. Referring to FIG. 1, in an inventory management environment 100, a plurality of inventoried sites 110-1 . . . 110-N (110 generally) perform sales, manufacturing, or consumption of inventory. Retail locations for direct consumer sales exhibit the most volatile inventory patterns, due to the random nature and external factors affecting sales, however manufacturing facilities and sites that consume inventory (such as product integrators, internet shippers, etc. products used in the local facility) also benefit from inventory management as disclosed herein. Each site 110 sends sales data and historic forecast data 112 to the inventory management system (IMS) 150. The IMS includes one or more servers 152 executing the DRIST system as outlined herein, which may also be located at the individual sites 110, rather than in a central repository. The sales data includes inventory depletion statistics for each item, or SKU/UPC for each sales period, typically days, in the previous sales cycles (i.e. weeks), typically 4-7 weeks of inventory cycles. Inventory depletion refers to sites 110 that consume inventory with or without direct sales. In either case, the sales data 112 depicts item counts sold during each sales period. The server stores the data 112 as sales history in a repository 154, and employs the sales data 112 for generating orders 120 to replenish inventory, as discussed further below. The orders 120 include a set of items and a quantity for each item for maintaining the inventory level at the site 110. A vendor or distribution center 130 receives the orders 120 for fulfillment by inventory replenishment 132, typically truck deliveries, however any suitable delivery mechanism may be employed. Multiple vendors and/or distribution centers 130 may be employed, as each item has a specific count for reordering, and a specific lead time from ordering until arrival in inventory at the site 110. Inventory replenishment 132 then arrives at the sites 110 and is reflected in the inventory count. As indicated above, a particular feature is to compute the orders 120 such that a targeted percentage of locations (e.g. 95%) are in stock with a specified item (SKU) at any particular time.

Many retail ordering schemes rely on days of the week for sales periods and sales cycles. In one configuration, in an inventory management environment having inventory statistics, in which the inventory statistics are specific to each day of the week, the method of computing target inventory levels includes gathering, for each day of the week, inventory level statistics from previous sales. The method computes, based on the inventory level statistics, an inventory level for each day of the week, such that the safety stock accommodates variations in inventory between the different days of the week. The server 152 renders, for each of a plurality of items, a stocking level indicative of the target inventory level including the safety stock for each day of the week. The server 152 computes an ordering quantity based on a lead time such that the ordered quantity arrives to satisfy the rendered stocking level on the determined day of the week. Identifying the actual stock levels includes identifying stock levels on the day of the week from previous weeks from the history data in the repository 154, thus focusing on the same day of the week over time, rather than an average of all days in the week.

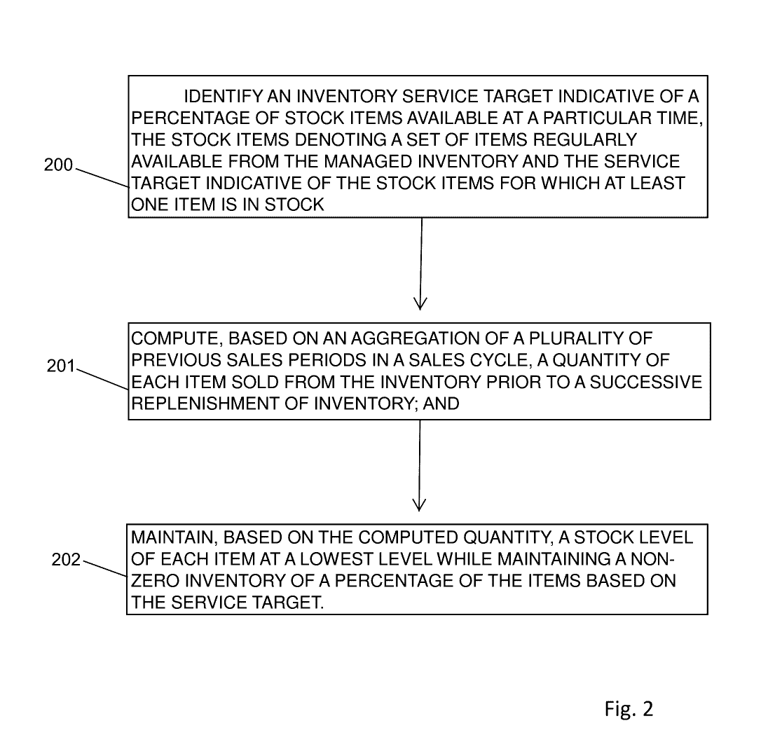

The sales period and cycle need not be limited to the days of the week. FIG. 2 is a flowchart of inventory management in the system of FIG. 1. Referring to FIGS. 1 and 2, at step 200, the method of managing inventory as disclosed herein includes identifying an inventory service target indicative of a percentage of stock items available at a particular time, such that the stock items denote a set of items regularly available from the managed inventory and the service target is indicative of the desired In-Stock level, equal to the percentage of stock items for which at least one item is in stock. The service target specifies the desired percentage of SKUs, (item at a location) for which at least one is in stock. In general, higher service levels cause the required safety stock levels to rise exponentially as the target approaches 100%, as it is difficult to predict all scenarios that permit in-stock status of all items.

The server 152 computes, based on an aggregation of previous sales periods in a sales cycle, a quantity of each item sold from the inventory prior to a successive replenishment of inventory, as depicted at step 201. The weekly sales cycle defines a sequence of sales periods (typically days), such that the aggregation of previous sales periods includes a set of corresponding sales periods in the sales cycle independently of other sets of sales periods. The result is that the corresponding sales periods are defined by similar positions in the sequence. In an example configuration, the sales period may be a day in a weekly sales cycle. In other words, the safety stock needed on a Saturday is based on previous sales data for N previous Saturdays, rather than N previous calendar days.

The server 152 renders orders 120 for maintaining, based on the computed quantity, a stock level of each item at a lowest level while maintaining a non-zero inventory of a percentage of the SKUs based on the service target, as shown at step 202. Typically these take the form of orders sent directly to one or more vendors or to one or more distribution centers 130 for fulfillment and delivery to the individual sites 110.

In configurations herein, the site 110 assigns, for each item of the set of regular stock items, a unique identifier denoting the particular item. Such identification may be done by a UPC (Universal Product Code) scanable bar code or RFID tag, or other suitable mechanism. Often, the identifier is equivalent to or mapped to a SKU (Stock Keeping Unit), common in vendor environments. Since the unique identifier is specific to a type of item and the location it is sold, the SKU of a particular item may differ from site 110 to site, even though the UPC symbol is the same.

The orders 120 invoke a replenishment mechanism for the item corresponding to each of the unique identifiers through the distribution center 130. To determine the safety stock, configurations herein compute a variable order interval based on lead times and an order interval forecast bias indicative of variations in expected demand, in which each item has an independent forecast bias for each sales period, thus avoiding generalizations that occur when sales are averaged over an entire week.

The server 152 computes a request to render an order quantity based on the computed safety stock for items in need of restocking, and generates the order quantity based on the current inventory and computed safety stock in an order 120. The server sends the generated order 120 to a replenishment facility such as the vendor or distribution center 130 operable to arrange a shipment 132 based on the order 120. In the example shown, the sales period corresponds to a day of the week and the sales cycle corresponds to a week, and the unique identifier denotes a SKU, or a type of product at a location, as indicated above. Alternate designations of sales periods, such as half days (12 hours) or even hourly may be appropriate in highly fluid environments.

As a stepwise process, the method computes a safety stock for each item by gathering for each item a history of inventory sold, and a history of sales forecasts, over the same or corresponding sales periods in the sales cycles (e.g. every Saturday). For each item of the plurality of items, the server 152 computes an expected quantity sold for each period of a sales cycle based on the history, and identifies, for each item, a deviation range of the expected quantity for each period. The server 152 aggregates, for the periods remaining until a replenishment of inventory, the deviation range, and computes the safety stock, thus addressing the nondeterministic aspects of the inventory prediction.

Aggregating the deviation range includes an aggregation of a forecast deviation for each day in the current ordering interval until a successive delivery of additional inventory for the item. The deviation range is based on a statistical parameter for maintaining a target percentage of items in stock (based on the % of locations having a particular items in stock, as discussed above). The safety stock needs to accommodate all sales periods, or days, until the next delivery, not just a single day of higher than average sales.

In a particular arrangement shown by the example herein, in an inventory management environment having historical sales statistics pertaining to day of week sales, the method of computing target inventory levels includes gathering, for each day of the week, forecast error statistics from previous sales, and computing, based on the forecast error statistics, a safety stock for each day of the week, in which the forecast error is independent of forecast error for other days of the week. The safety stock accommodates variations in forecast error between the different days of the week. The method then renders an order 120 indicative of the target safety stock for each day of the week. The order 120 involves computing an order quantity based on a lead time such that the ordered quantity arrives to satisfy the rendered stocking level on the determined day of the week. It should be emphasized that the safety stock encompasses the forecast error for each day until the next replenishment. Thus, the transport time from the vendor or distribution center 130 to each site 110 is considered. So if the next replenishment (delivery) is three days out, the safety stock encompasses additional stock in anticipation of variances for all three days. Since each SKU is specific to the site location, variations in lead time to the different sites is also covered.

FIG. 3 depicts safety stock in the managed inventory of FIG. 1. Referring to FIGS. 1 and 3, a safety stock covers the maximum expected variation for the sales period or periods until the next replenishment. The vertical axis 302 shows inventory levels, and the horizontal axis 304 depicts the succession of sales periods 310. The Safety Stock Quantity (SSDOW) is calculated for each period as a function of: Service Target, Forecast Error by DOW, Lead Time, VFI, and VOL Sales periods 310-1 . . . 310-5 (310 generally), such as days of the week (DOW) are shown as the vertical lines. The top portion 320 depicts the daily order lead times 322 from a distribution center (DC) directly to a store for meeting the inventory demand on the indicated period 310. Variation areas 320-1 . . . 320-5 (320 generally) indicate the fluctuating demand variability by DOW leading up to the end of the sales period 310, which meets the safety stock level 330-1 . . . 330-5 (330 generally) just as the inventory level approaches depletion, prior to the next replenishment. A higher safety stock 350 indicates an item having a greater variability of demand, while a lower safety stock 352 indicates a more stable item turnover rate.

FIG. 4 shows differences in inventory levels between conventional approaches and the configurations disclosed. Referring to FIGS. 1, 3 and 4, by maintaining inventory to include the safety stock 330, inventory levels may be kept more level, as shown by managed inventory level 410. In contrast, a conventional approach tends to follow a stocking level having more peaks 430 and valleys 431, indicating stocking levels well in excess of a safety stock level, then falling to a precarious level before replenishment, risking an item depletion (zero stock).

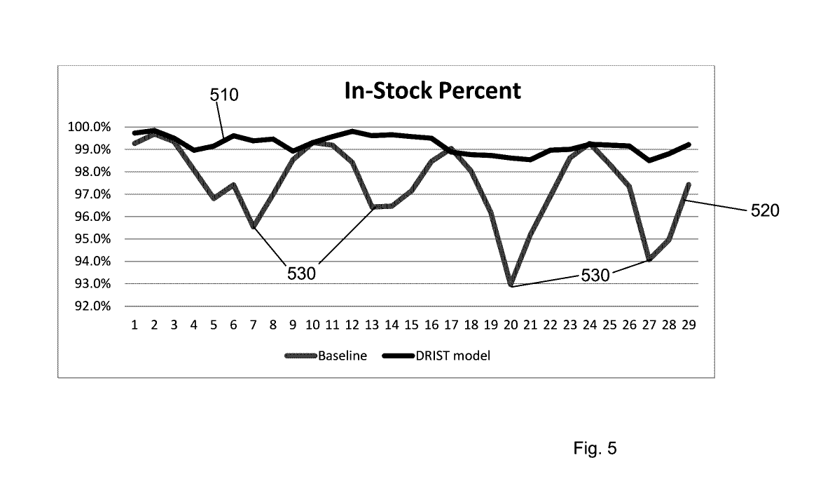

In the example of FIG. 5, an implementation of the disclosed approach achieved a 7.4% reduction in average daily inventory levels. This is a permanent reduction of inventory, reducing the requirement for working capital and liberating shelf space to add other products without expanding facilities. These improvements also reduce operating costs and boost profitability. Referring to FIG. 5, a stocking percentage 510 (in-stock %) of SKUs for the disclosed system are shown, along with in-stock percentages 520 for conventional approaches. The conventional approaches have substantial valleys 530, based on methodology that does not adequately recognize the difference in forecast error by the day of the week.

FIG. 5 shows inventory levels (in-stock %) based on the proposed and conventional (baseline) approaches. Planners never want to run out of stock, but they also want to minimize spoilage. Excess inventory not only incurs carrying costs, it may significantly contribute to waste as well. Spoilage is minimized when inventories are closely managed. Especially for products that are time sensitive, such as produce, where berries may spoil in 3-5 days, it is critical to manage inventory levels closely.

Depicted further below is a more detailed stepwise specification of the procedures and methods outlined above. The DRIST model analyzes forecast bias and error by day of week to set the most efficient safety stock value by store SKU (item at a location), based on daily variations. Frequent deliveries, often daily, allow the retail store to restock shelves directly rather than double handling product to the back room first, and then replenishing shelves in a second step. However, with frequent deliveries and short lead times, setting safety stock levels requires very precise calculation of demand forecast error by each DOW (Day Of Week), over each VFI. It is not possible to calculate retail safety stocks accurately from average demand and average forecast error, as is the case with most software solutions.

The Daily Retail Inventory-Service Target (DRIST) Model is intended for integration into any replenishment planning system. The DRIST model runs in a weekly batch process, as an automated, stand-alone, backend software program. It uses a weekly update of historic, daily point-of-sale (POS) sales, as well as historic allocated daily demand forecasts, to calculate forecast error and hence the daily safety stock requirements, by SKU, (by item and location).

The DRIST Model minimizes retail inventory levels while achieving desired Service Target levels. Features include the following:
A Day-of-the-Week (DOW) definition of a planning period for which point of sale (POS) and forecasting data is available, which can reflect one hour, one day, or some period of a number of hours in between, such as 8 hours or 12 hours. It is typically one 24 hour calendar day
A Variable Order Interval (VOI) for each SKU, which is the fixed order cycle for that SKU, rather than finding a reorder point.
A detailed analysis of Total Forecast Error, separating out the Forecast Bias from the Random Forecast Error.
A detailed analysis for every SKU (every item at every store) based on a Variable

Forecast Interval (VFI), instead of the standard weekly forecast period.
Computation of the total Random Forecast Error over the VFI period, and applying it by the day of the week (DOW), instead of using the weekly forecast error.
Adding the Forecast Bias to the Safety Stock over the VOI period, to correct for the bias in the forecasted demand.
The calculation of the target safety stock level, SS_{DOW}, calculated by DOW for each day of arrival.

Outlined below are the computed quantities and descriptions. In a particular configuration, the disclosed formulas are expressed in a spreadsheet application, which lends itself well to a large number of items (SKUs). Accordingly, the disclosed method computes, fore each identified item at a location (typically a SKU or other unique identifier), a variation in the mean squared error over the variable forecast interval. It should be noted that a particular type of item may have a different SKU at different locations, for computing the safety stock levels per location for each item type. Each unique identifier therefore has a variable forecast interval, and the variable forecast interval is based on a predetermined granularity. The predetermined granularity may be any suitable period, such as includes days of the week, portions of days of the week (i.e. half days), and hours. In one example configuration, these may encompass computing mean squared error for each unique identifier for each day of week.

In the examples that follow, the major parameters and computations include the following:

SSDOW or SS_{DOW} is the safety stock quantity calculated for each Day-of-the-Week (DOW). It should be calculated each week for the next 2-3 weeks, based on historic forecast error information. Forecast error data should be generated using the most current history period of between 4 and 7 weeks. The SS_{DOW} is then set for each future day appropriate to its day of the week, for the following 2 to 3 weeks, and recalculated and re-set each week.

DOW reflects the Day-of-the-Week (DOW) definition of a planning period for which point of sale (POS) and forecasting data is available, which can reflect one hour, one day, or some period of a number of hours in between, such as 8 hours or 12 hours. The examples in this description use a calendar 24 hour DOW reflecting the retail selling week: Sunday, Monday, Tuesday, Wednesday, Thursday, Friday, and Saturday.

A Z-Factor is derived from tables for a one-tailed test for the Normal Distribution. It is used as a multiplier times the MIRFE to achieve the user's Service Target; for example, the following are just a few of the more common settings:
For 85% Service Target, Z=1.036
For 90% Service Target, Z=1.282
For 95% Service Target, Z=1.645
For 98% Service Target, Z=2.054
For 99% Service Target, Z=2.326

MIRFE is the Mean Interval Random Forecast Error, which is a summation of the Daily Random Forecast Errors (DRFE), counting back from the DOW day of arrival over the Variable Forecast Interval, for each day-of-the-week. For high velocity products, the VFI is typically anywhere from 2 to 9 days. The MIRFE reflects the mean squared error of the random error component over the VFI, most of which is the lead time.

VOIFB is the Variable Order Interval Forecast Bias, summed over the VOI Variable Order Interval, for each day-of-the-week. This portion of the safety stock calculation is designed to correct for the bias in the demand forecast in the cycle stock plan. For high velocity products, the VOI is typically 1 to 2 days. The VOIFB reflects the forecast bias that was removed from total forecast error used in the MIRFE calculation.

Depicted below are an example of particular steps and parameters gathered from the history 154 and applied to generate the orders 120 for restocking. Alternate configurations may employ other calculations and parameters for implementing the disclosed system and method. In the example below, the DRIST Model computes a daily SS quantity using a series of calculations based on DOW POS history and DOW forecasts. The following steps demonstrate these calculations in the sequence required for a weekly batch program that would set new SS targets by DOW.

Step 1: Calculate Daily Total Forecast Error™ (DTFE™)

The Daily Total Forecast Error™ (DTFE™) is a number calculated for each SKU (each product at each location) for each day of the 4 to 8 weeks of history that will be used to analyze forecast error, and from which the daily safety stock quantity (SS_{DOW}™) will be computed.

DTFE™=FC−POS

Where:
FC=Forecast Qty=the historic forecast used to generate the demand requirements for each day; often it is allocated to a daily quantity by percentage from the weekly demand forecast
POS=Actual Qty=the actual daily point-of-sale (POS) sales quantity recorded for each day
DTFE™ is null if either FC or POS is null

Step 2: Calculate Day-of-the-Week Forecast Bias™ (DOWFB™)

The DOW Forecast Bias™ (DOWFB™) is a number calculated for each SKU (each product at each location) for each day-of-the-week (DOW™) for the 4 to 8 weeks of history that will be used to analyze forecast error. For each DOW:

DOWFB™=AVERAGE(FC)−AVERAGE(POS)
For Tcalc>Tcrit otherwise DOWFB™=0

Where:
Tcalc=ABS(DOWFB™)/(Standard Deviation (DTFE™) /(SQRT(NWH)))
NWH=number of weeks of history=number of non-null DTFE values for each DOW
DF (Degrees of Freedom)=NWH−1
Tcrit=values from 2-tailed t-Test for 80% confidence level:
   For DF=0, Tcrit=999999
   For DF=1, Tcrit=3.078
   For DF=2, Tcrit=1.885
   For DF=3, Tcrit=1.637
   For DF=4, Tcrit=1.533
   For DF=5, Tcrit=1.476
   For DF=6, Tcrit=1.439
   For DF=7, Tcrit=1.411

Step 3: The Daily Random Forecast Error™ (DRFE™)

The Daily Random Forecast Error (DRFE™) is a number calculated for each SKU (each product at each location) for each DOW™ of the 4 to 8 weeks of history that will be used to analyze forecast error. It is simply the Daily Total Forecast Error minus the appropriate Day-of-the-Week Forecast Bias:

DRFE™=DTFE™−DOWFB™

Step 4: The Variable Order Interval™ (VOI™)

The Variable Order Interval™ (VOI™) is a duration in days, calculated for each SKU for each Day, based on when the next order is scheduled to be placed. For daily ordering, the VOI™=1. If the next Ordering Day is not until the day after tomorrow, the VOI™=2. For each day of the plan period (NPD) calculate the number of days to the next order date based on OP (Order Pattern):

VOI™=number of days to next OP day

Step 5: The Variable Forecast Interval™ (VFI™)

The Variable Forecast Interval™ (VFI™) is a duration in days, calculated for each SKU, based on the total lead time from order to delivery, plus the Variable Order Interval. The VFI™ reflects the period during which forecast error must be covered by safety stock before the next ordering opportunity for each day of the NPD:

VFI™=LT+VOI

Step 6: The Aggregated VFI Error™ (AVFIE™)

The Aggregated VFI Error™ (AVFIE™) is calculated as the algebraic sum of all the DRFE™ counting back from the day of arrival over the VFI™, calculated for each of the NWH historic weekly periods, by DOW™, for each SKU:

AVFIE_{DOW}=Σ(DRFE_{DOW}) for i=VFI to 1 by −1

Step 7: The Sum of Squares Random Forecast Error™ (SSRFE™)

The Sum of Squares Random Forecast Error™ (SSRFE™) is calculated across NWH, number of all non-null historic Forecast Intervals, from the AVFIE™, by DOW™, for each SKU:

SSRFE_{DOW}=Σ(AVFIE_{DOW})² for i=1 to NWH by 1

Step 8: The Mean Interval Random Forecast Error™ (MIRFE™)

The Mean Interval Random Forecast Error™ (MIRFE™) is calculated as the square root of the sums of squared error (of all NWH SSRFE™ sums of squared errors) by DOW™ for each SKU:

MIRFE_{DOW}=SQRT((SSRFE_{DOW})/NWH)

Where:
NWH=No. historic weekly periods

Step 9: The VOI Forecast Bias™ (VOIFB™)

The VOI Forecast Bias™ (VOIFB™) is calculated as the summation of DOWFB™ over the VOI™, by DOW™, for each SKU:

VOIFB_{DOW}=Σ(DOWFB_{DOW}) for i=1 to VOI

Step 10: The DRIST Safety Stock Quantity by Day-of-the-Week (SS_{DOW}™) is Derived

Finally, the DRIST™ Safety Stock Quantity by Day-of-the-Week (SSDOW™), for each day of arrival, is calculated as the sum difference of the MIRFE™ and the VOIFB™, by DOW™, for each SKU for each day over the NPD:

SS_{DRIST}=Z*MIRFE_{DOW}−VOIFB_{DOW}

Where:
Z=Two-tailed Normal Distribution for Service Level (SL) target; for example, the following are just a few of the more common settings:
   For 85% SL, Z=1.036
   For 90% SL, Z=1.282
   For 95% SL, Z=1.645
   For 98% SL, Z=2.054
   For 99% SL, Z=2.326
      The orders 120 are generated by computing, for each item, a summation of the forecast bias for each sales period of the variable order interval, computing a safety stock based on the summed forecast bias and the mean interval forecast deviation, and rendering, for each item and each sales period, an order quantity based on the computed safety stock in the form of the order 120 sent to the vendor or distribution center 130.

The Z-factor, discussed above, is responsive to the user via the Service Target percentage for user-specified sets of SKUs. A planner can set Service Targets in whatever ways the business has segmented their product line. So, any given set of products, whether by department, by velocity, by strategic importance, and/or by demand variability, can have the most appropriate Service Target. Each set of SKUs, even down to individual SKUs, can be individually set with the most appropriate target Service Target for the business.

In fact, Service Targets can even be “time-phased” so that future periods may have a different Service Target than the current period. This time-phasing enables the planner to set Service Targets correctly for month-end, quarter-end, or year-end periods when there may be a need to precisely control and reduce inventories. On the other hand, if a planner needs to build inventories, for example to anticipate a shut-down of a providing production plant, the future Service Target can be increased.

With the DRIST model, the planner or manager controls the Service Target as the single lever for optimized inventory control. The planner does not need to create a forward coverage safety stock factor or compute a safety stock level in sidebar calculations or based on anecdotal past experience. The Service Target is the only setting the planner needs to manage.

In an example arrangement, the above method may be implemented in a standalone application, or integrated in a host application such as a spreadsheet or inventory system.

In particular configurations, the disclosed approach may be employed in conjunction with specialized and/or particularly high volume retail sales environments. In large logistics and distribution operations, it is beneficial to load trucks as full as possible, and in the event deferral of items to a successive trip is needed, to select those items which will have a least likely chance of interrupting sales activity. Accordingly, configurations herein are operable in conjunction with a POS (Point of Sale) scanning system to identify high velocity or high turnover items that tend to be sold and replenished faster than other items. A UPC bar code symbol on an item includes a field, designation or value, that alone or in conjunction with a database lookup, designates an item as a high velocity item appropriate for safety stock treatment as defined herein.

A high velocity item may be accommodated by identifying, for each of a plurality of items represented in an inventory database, a field for a product identifier and a field denoting a safety stock for the item, and determining, for each of the product identifiers, a product segmentation field based on product velocity indicative of increased product replenishment demands resulting from a sales volume. The disclosed approach determines based on the velocity field, whether to compute a safety stock, i.e. whether the overhead and burden to resupply according to the safety stock is worthwhile given the product throughput.

In other configurations, supply logistics may invoke a delivery frequency higher than 1 truck a day, hence triggering a resupply window with a higher granularity. In such a case, the safety stock may be more specific than an individual day, such as a Monday AM and Monday PM, or to designate multiple delivery or time windows within a particular day of the week, such as 7:00 AM, 11:00 AM and 4:00 PM.

The claimed approach may be employed in a business method of implementing supply logistics and designating deliveries (i.e. trucks) and manifest (i.e. contained items) in accordance with demand and profit margins of the transported items. In other words, the high velocity items might be deemed to have priority space on a particular delivery, but could further be selected based on a profit margin or markup on the included items, and items with the greatest revenue generation potential selected for inclusion.

In such a product inventory shipping environment having a plurality of transport vehicles, each vehicle (truck) is configured for receiving a fixed payload of items for delivery to a sales location for inventory replenishment. The disclosed approach provides guidance in loading a delivery vehicle, by, for each item of a plurality of items including a first item and a second item, computing a safety stock and determining, based on the computed safety stock of the first item and the second item, a quantity of each of the first item and the second item to be loaded into the delivery vehicle. The approach recomputes a truck loading quantity based on the safety stock if insufficient space is available in the delivery vehicle for the determined quantity of the first item and the second item, meaning that certain items would need to be omitted and deferred to a successive delivery.

The use of the product segmentation/velocity may be used in conjunction with POS scanning of item markings. In a product sales environment having a plurality of retail sales locations, such that each location has a stock level of a plurality of commodity items, and each of the items defines a product velocity based on a need for replenishment for maintaining the stock level, a product marking indicates a product for indicating high velocity replenishment processing. This approach designating a product identifier for each item of the plurality of items, such that the product identifier common to each item of a specific product and including a velocity subfield indicative of a sales volume of the product, and may be a bar code or similar label, possibly with a dedicated field, bar code portion, or symbol for velocity. A product or sales database stores, based on a determination of whether the item has a sales volume in excess of a predetermined velocity threshold, an indication of a high velocity item in the designated product identifier. The high velocity product identifier is affixed or appended to each item (i.e. may be marked in conjunction with a preexisting UPC symbol).

Upon customer checkout, a POS server receives, for at least one of the items, a scan message from a POS station indicative of a stock level change of the scanned item, and computing, if the scanned item is from a product identifier having a high velocity indication, a safety stock for the item, as previously described.

It will be appreciated by those skilled in the art that alternate configurations of the disclosed invention include a multiprogramming or multiprocessing computerized device such as a workstation, handheld or laptop computer or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a non-transitory computer-readable storage medium including computer program logic encoded thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a non-transitory computer readable storage medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

What is claimed is:

1. In an inventory control system having a database including a product identifier corresponding to each of a plurality of commodity items, a method of updating a delivery quantity in the database of each of the commodity items, comprising:
identifying, for each of a plurality of items represented in an inventory database, a field for a product identifier and a field denoting a safety stock for the item;
determining, for each of the product identifiers, a product velocity field indicative of increased product replenishment demands based on a sales volume;
determining, based on the velocity field, whether to compute a safety stock, the safety stock computation further comprising:
identifying each SKU of a plurality of stock SKUs as a unique combination of an item at a location;
identifying a customer service level target defined as a percentage of the stock SKUs available at a particular time, at one or multiple locations, regularly available from the managed inventory, and the customer service level target further indicative of an expected percentage of the stock SKUs for which at least one item is in stock; identifying, in a retail business, a natural pattern defining a sales cycle, the sales cycle being a week and the sales periods being days of the week (DOW), with the sales cycle defining a sequence of the sales periods;
computing, based on a statistical inference from previous sales periods in the sales cycle, a forecast bias and random forecast error for each stock SKU sold from the inventory, for each day of the week (DOW), the statistical inference based on a sales history including at least 4 previous sales cycles of corresponding sales periods defined by a similar day of the days of the week;
computing, prior to placing an order, a safety stock quantity for each day of a scheduled order arrival, according to its DOW, based on the standard deviation of the computed random forecast error for the days of the week spanning a variable forecast interval (VFI), multiplied by a Z factor based on the customer service level target, and subtracting the computed forecast bias for each day of a variable order interval (VOI), computing the safety stock further comprising:
computing the VFI based on a sum of the lead time and VOI, expressed as specific days of the week within the VFI, where the lead time comprises the days of the week from order placement to order arrival, and the VOI comprises the specific days of the week in an order interval from order arrival until the arrival of the next successive order;
aggregating the sums of the squares of the random forecast error, for the days of the week defining the VFI period taken together, for all the weeks of the sales history, and then calculating the average mean squared error, by dividing the sum of squares by the number of historic observations, and then calculating the standard deviation by taking the square root of the aggregated sums;
maintaining, based on the computed safety stock quantity, for each day of the week of a successive sales cycle, a stock level of each SKU at the lowest possible level while maintaining the target level of non-zero inventory of a percentage of the stock SKUs based on the customer service target percentage;
rendering an order quantity for each scheduled order arrival day that is based on the safety stock so calculated for that order arrival day, summing forecast error over the VFI, in a non-transitory medium of expression for initiating inventory replenishment; and updating the computed safety stock for each item in the inventory database.

2. The method of claim 1 further comprising mapping the product identifier to the velocity field.

3. The method of claim 2 wherein the velocity field is a subfield of the product identifier.

4. The method of claim 3 wherein the velocity field is received by an optical scan based on a product marking.

5. In a product inventory shipping environment having a plurality of transport vehicles, each configured for receiving a fixed payload of items for delivery to a sales location for inventory replenishment, a method of loading a delivery vehicle, comprising:
for each item of a plurality of items including a first item and a second item, computing a safety stock and determining, based on the computed safety stock of the first item and the second item, a quantity of each of the first item and the second item to be loaded into the delivery vehicle; and
recomputing safety stock if insufficient space is available in the delivery vehicle for the determined quantity of the first item and the second item, computing the safety stock further comprising:
identifying each SKU of a plurality of stock SKUs as a unique combination of an item at a location;
identifying a customer service level target defined as a percentage of the stock SKUs available at a particular time, at one or multiple locations, regularly available from the managed inventory, and the customer service level target further indicative of an expected percentage of the stock SKUs for which at least one item is in stock; identifying, in a retail business, a natural pattern defining a sales cycle, the sales cycle being a week and the sales periods being days of the week (DOW), with the sales cycle defining a sequence of the sales periods;
computing, based on a statistical inference from previous sales periods in the sales cycle, a forecast bias and random forecast error for each stock SKU sold from the inventory, for each day of the week (DOW), the statistical inference based on a sales history including at least 4 previous sales cycles of corresponding sales periods defined by a similar day of the days of the week;
computing, prior to placing an order, a safety stock quantity for each day of a scheduled order arrival, according to its DOW, based on the standard deviation of the computed random forecast error for the days of the week spanning a variable forecast interval (VFI), multiplied by a Z factor based on the customer service level target, and subtracting the computed forecast bias for each day of a variable order interval (VOI), computing the safety stock further comprising:
computing the VFI based on a sum of the lead time and VOI, expressed as specific days of the week within the VFI, where the lead time comprises the days of the week from order placement to order arrival, and the VOI comprises the specific days of the week in an order interval from order arrival until the arrival of the next successive order;
aggregating the sums of the squares of the random forecast error, for the days of the week defining the VFI period taken together, for all the weeks of the sales history, and then calculating the average mean squared error, by dividing the sum of squares by the number of historic observations, and then calculating the standard deviation by taking the square root of the aggregated sums;
maintaining, based on the computed safety stock quantity, for each day of the week of a successive sales cycle, a stock level of each SKU at the lowest possible level while maintaining the target level of non-zero inventory of a percentage of the stock SKUs based on the customer service target percentage; and
rendering an order quantity for each scheduled order arrival day that is based on the safety stock so calculated for that order arrival day, summing forecast error over the VFI, in a non-transitory medium of expression for initiating inventory replenishment.

6. In a product sales environment having a plurality of retail sales locations, each having a stock level of a plurality of commodity items, each of the items defining a product velocity based on a need for replenishment for maintaining the stock level, a method of marking a product for indicating high velocity replenishment processing, comprising:
designating a product identifier for each item of the plurality of items, the product identifier common to each item of a specific product and including a velocity subfield indicative of a sales volume of the product;
storing, based on a determination of whether the item has a sales volume in excess of a predetermined velocity threshold, an indication of a high velocity item in the designated product identifier;
affixing the product identifier to each item;
receiving, for at least one of the items, a scan message from a POS station indicative of a stock level change of the scanned item;
computing, if the scanned item is from a product identifier having a high velocity indication, a safety stock for the item, the safety stock computation further comprising:
identifying each SKU of a plurality of stock SKUs as a unique combination of an item at a location;
identifying a customer service level target defined as a percentage of the stock SKUs available at a particular time, at one or multiple locations, regularly available from the managed inventory, and the customer service level target further indicative of an expected percentage of the stock SKUs for which at least one item is in stock;
identifying, in a retail business, a natural pattern defining a sales cycle, the sales cycle being a week and the sales periods being days of the week (DOW), with the sales cycle defining a sequence of the sales periods;
computing, based on a statistical inference from previous sales periods in the sales cycle, a forecast bias and random forecast error for each stock SKU sold from the inventory, for each day of the week (DOW), the statistical inference based on a sales history including at least 4 previous sales cycles of corresponding sales periods defined by a similar day of the days of the week;
computing, prior to placing an order, a safety stock quantity for each day of a scheduled order arrival, according to its DOW, based on the standard deviation of the computed random forecast error for the days of the week spanning a variable forecast interval (VFI), multiplied by a Z factor based on the customer service level target, and subtracting the computed forecast bias for each day of a variable order interval (VOI), computing the safety stock further comprising:
computing the VFI based on a sum of the lead time and VOI, expressed as specific days of the week within the VFI, where the lead time comprises the days of the week from order placement to order arrival, and the VOI comprises the specific days of the week in an order interval from order arrival until the arrival of the next successive order;
aggregating the sums of the squares of the random forecast error, for the days of the week defining the VFI period taken together, for all the weeks of the sales history, and then calculating the average mean squared error, by dividing the sum of squares by the number of historic observations, and then calculating the standard deviation by taking the square root of the aggregated sums;
maintaining, based on the computed safety stock quantity, for each day of the week of a successive sales cycle, a stock level of each SKU at the lowest possible level while maintaining the target level of non-zero inventory of a percentage of the stock SKUs based on the customer service target percentage; and
rendering an order quantity for each scheduled order arrival day that is based on the safety stock so calculated for that order arrival day, summing forecast error over the VFI, in a non-transitory medium of expression for initiating inventory replenishment.

7. The method of claim 6, wherein the safety stock based on the high velocity items defines an enhanced precision safety stock, further comprising using the enhanced precision safety stock to calculate a transfer order quantity, equal to the summed forecast until the next successive shipment, plus the calculated safety stock, minus an updated on-hand inventory quantity from the POS system logged at the end of the latest sales period, and minus other deliveries in-transit for the same items to the same location.

8. The method of claim 6 further comprising a delivery frequency greater than 1 truck a day, wherein each day of the week includes multiple sales periods and the computed safety stock defines each of the multiple sales periods in each day for each location.

9. The method of claim 6 further comprising:
receiving a request to render an order quantity for at least one of the SKUs;
sending a generated order that includes safety stock requirements to a replenishment facility operable to arrange a shipment based on the order.

10. The method of claim 5 wherein the unique identifier denotes an item at a location, a common product at different locations having different unique identifies at each location.

11. A business method for injecting a commerce stream with revenue producing items comprising:
identifying each SKU of a plurality of stock SKUs as a unique combination of an item at a location;
identifying a customer service level target defined as a percentage of the stock SKUs available at a particular time, at one or multiple locations, regularly available from the managed inventory, and the customer service level target further indicative of an expected percentage of the stock SKUs for which at least one item is in stock;
identifying, in a retail business, a natural pattern defining a sales cycle, the sales cycle being a week and the sales periods being days of the week (DOW), with the sales cycle defining a sequence of the sales periods;
computing, based on a statistical inference from previous sales periods in the sales cycle, a forecast bias and random forecast error for each stock SKU sold from the inventory, for each day of the week (DOW), the statistical inference based on a sales history including at least 4 previous sales cycles of corresponding sales periods defined by a similar day of the days of the week;
computing, prior to placing an order, a safety stock quantity for each day of a scheduled order arrival, according to its DOW, based on the standard deviation of the computed random forecast error for the days of the week spanning a variable forecast interval (VFI), multiplied by a Z factor based on the customer service level target, and subtracting the computed forecast bias for each day of a variable order interval (VOI), computing the safety stock further comprising:
computing the VFI based on a sum of the lead time and VOI, expressed as specific days of the week within the VFI, where the lead time comprises the days of the week from order placement to order arrival, and the VOI comprises the specific days of the week in an order interval from order arrival until the arrival of the next successive order;
aggregating the sums of the squares of the random forecast error, for the days of the week defining the VFI period taken together, for all the weeks of the sales history, and then calculating the average mean squared error, by dividing the sum of squares by the number of historic observations, and then calculating the standard deviation by taking the square root of the aggregated sums;
maintaining, based on the computed safety stock quantity, for each day of the week of a successive sales cycle, a stock level of each SKU at the lowest possible level while maintaining the target level of non-zero inventory of a percentage of the stock SKUs based on the customer service target percentage;
rendering an order quantity for each scheduled order arrival day that is based on the safety stock so calculated for that order arrival day, summing forecast error over the VFI, in a non-transitory medium of expression for initiating inventory replenishment; and
updating the computed safety stock for each item in the inventory database;
determining that an item replenishment based on the computed safety stock for all items in a shipment to a location exceeds the capacity of a delivery vehicle containing the replenished items; and
selecting a subset of items having a higher profit margin than other items for inclusion on the delivery vehicle.
